(19) United States
(12) Patent Application Publication
(10) Pub. No.: US 2009/0232584 A1
(43) Pub. Date: Sep. 17, 2009

(54) APPLICATOR DEVICE

(75) Inventors: Leo Clifford Pires, Basking Ridge, NJ (US); Roger Hwang, Maple Ontario (CA); Smitaa Srivastava, New Delhi (IN); Manisha Kohli, New Delhi (IN)

Correspondence Address: PATTERSON & SHERIDAN L.L.P. NJ Office, 3040 Oak Post Road, Suite 1500, Houston, TX, 77056-6582, US

(73) Assignee: Zen Design Solutions Limited, Wanchai (HK)

(21) Appl. No.: 12/047,918

(22) Filed: Mar. 13, 2008

(51) Int. Cl. B43K 5/00

(52) U.S. Cl. 401/202

(57) ABSTRACT

The present invention generally relates to applicators. More particularly the invention relates to applicator devices to be used for consumer products such as cosmetics, skin care, hair care or paint products. The applicator device of the present invention provides for convenience in storing as well as applying consumer products wherein the handle of the applicator device acts as a reservoir for the products. Also disclosed is the usage of such an applicator device in a ready to use kit where the applicator handle stores an additional product.

### BACKGROUND

1. Field of the Invention

Embodiments of the present invention generally relate to applicators. More particularly the invention relates to applicator devices to be used for consumer products such as cosmetics, skin care, hair care or paint products. The applicator device of the present invention provides for convenience in storing as well as applying consumer products wherein the handle of the applicator device stores the product. Also disclosed is the usage of such an applicator device in a ready to use kit where the applicator handle stores an additional product.

2. Description of the Related Art

There are known various applicators comprising of an applicator element attached to a handle wherein the handle acts as a support for the applicator element and also a tool for easy application. Also known are various applicators where the handle acts as a reservoir and the product flows through to the applicator element for the application of the product. Examples of such applicator devices include shaving brush with a foam dispenser in the handle or a tooth brush where toothpaste flows via the handle and through a hole between the bristles or also nail polish brushes, in which the nail polish likewise flows out of an inverted bottle directly between the brush bristles and thus can be spread on the fingernails. Such applicator elements have also existed on a large scale for years as shoe brushes. For example, U.S. Pat. No. 5,066,155 to English, et al. discloses a toothbrush and toothpaste dispensing unit, U.S. Pat. No. 4,930,923 to Reichmann et al. discloses a barrel shaped holder with an applicator attached at its front end and which has a valve arranged to be opened by an actuating means. With all these applicator devices there exists the difficulty of sealing the reservoir from outside, especially during the times when the applicator is not being used. Moreover, there also exists the problem of leakage in the usage of such applicators which makes their life very less and there is always a requirement of a means for addressing the leakage issue.

Further, a user would generally prefer that all the items required for usage of a product are readily available for application of that product. For example, a woman while applying any cosmetic would prefer to have the applicators to be present in the package itself for a ready and quick usage. Also, when at work, she may need to apply her favourite cosmetics products rapidly, several times a day and often in conditions such as whilst travelling in a car, or using a public transportation on the go. Also, she may want to have a different look for different occasions and would like to be able to have all the required products for a different look. To meet these requirements a woman will generally carry all the products along with different brushes for their usage in a make-up bag within her handbag. However it is often difficult to locate the required cosmetics product within the handbag or make-up bag rapidly especially when other personal items are also carried in the handbag.

There are also present various applicators which have a handle and a brush head. Also known are applicators which have detachable heads, however, the handle again is acting as a support in these cases. For example, U.S. Pat. No. 5,926,903 discloses a make-up brush wherein the brushing head and the stem are separably combined. Similarly U.S. Pat. No. 4,471,507 discloses paint brushes with detachable handle. However, the handle just acts as a support and does not contain any product. Therefore, it would be preferred if an applicator is provided that serves both the purposes of a storage package and an applicator. There exists a need for a portable applicator that also acts as a container for a particular product that can be easily carried in a kit for ready usage and can be used at will of the user where the applicator can be used irrespective of the fact that the handle contains the product.

Moreover, in the cosmetic area, there are cosmetics packs on the market where different cosmetics products, for example, blushers, eyeshadows, highlighters and powder, are packaged together. Although these are all ready-to-use kits, none of these known cosmetics packs is able to contain all the cosmetics products that a woman needs to make herself up for different looks in a single package. Moreover, none of the existing packages provide the accessibility for a liquid inside the package/kit itself. For example, to get a wet look, the user needs to either carry a converter in a separate container or use fluid if an when available. Therefore, there is a need for minimizing the number of products carried such that the bulk carried by the user is minimized and allows easy individual access and is capable of being used on the go.

### SUMMARY

According to an embodiment of the invention, an applicator device is provided which is capable of storing a product apart from being usable as an applicator. The applicator device comprises of a head portion and a gripping portion. The gripping portion further comprises of an elongated housing that terminates into a neck which defines an opening wherein the housing acts as a receptacle for containing a consumer product. The head portion further comprises of an applicator element and an applicator element holder.

According to another embodiment of the invention, the gripping portion may optionally comprise a spout that may be attached to the elongated housing of the gripping portion. The spout could be shaped according to the composition of the product stored in the housing.

According to another embodiment of the invention, the head portion is configured to be mounted on to the gripping portion by way of screwing or snapping onto the gripping portion or by any other suitable mechanism. To the proximal end of the applicator element holder is attached the applicator element while the distal end of the applicator element holder is configured to be mounted on to the gripping portion. Further, the applicator element holder has a partitioning wall that separates the opening of the elongated housing or the spout from the distal ends of the applicator element. The partitioning wall, towards the distal end of the holder component, has a suitable means to shut the opening of the elongated housing or the spout when the head portion is mounted on to the gripping portion. A suitable means for plugging the opening could be in the form of a protrusion being shaped according to the shape of the opening such as a pintle or a pimple which is capable of plugging the opening of the housing or spout.

According to yet another embodiment of the invention, the partitioning wall in the applicator element holder may be formed by way of provision of an inner cap that fits into the applicator element holder. The inner cap may have a suitable means to shut the opening of the elongated housing or the spout when the head portion is mounted on to the gripping portion.

According to yet another embodiment of the invention the housing of the gripping portion is squeezable to dispense the product contained in it.

According to yet another embodiment of the invention there is provided an applicator device in which there is no possibility of spill-over of the product during usage, as the consumer would use the applicator only after mounting the applicator head onto the gripping portion. Also, there is provided an applicator device that is compact and portable as it provides the user with an applicator that also holds the product.

According to yet another embodiment of the invention, it is also contemplated that this applicator device could be used as a component of a kit where the additional product having a complimentary composition than the products of the kit could be stored in the receptacle of the applicator device.

According to yet another embodiment of the invention, there could optionally be provided a cap to cover the applicator element for preventing any damage to the same when not in use.

According to yet another embodiment of the invention, the cap could be provided with a mixing well on its proximal end to enable the user to dispense the product into the well for usage with the applicator.

According to yet another embodiment of the invention, the applicator device could be provided with various head parts having different kinds of applicator elements which could be used interchangeably on the same handle thereby providing a wide usage of the applicator.

According to yet another embodiment of the invention, as the applicator could be used for a product other than the one stored in it, it provides for a multiple usage with a single head component applicator element, thereby providing a ready-to-use applicator device for the user.

According to yet another embodiment of the invention, the gripping portion can be, advantageously, transparent thereby enabling the consumer to see the product from the outside and in particular its colour.

According to yet another embodiment of the invention, the receptacle could store a wide variety of consumer products related to cosmetic, hair care, skin care or paint products. The examples of various consumer products that could be stored include but are not limited to a shimmer, primer, gel, powder, hair color, converter, paint color and pigment.

These and further aspects which will be apparent to the expert of the art are attained by an applicator device in accordance with the main claim.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an isometric view of the applicator device according to one embodiment of the present invention.

FIG. 2 illustrates an exploded view of the applicator device as shown in FIG. 1.

FIG. 3 is front view of the applicator device of FIG. 1;

FIG. 4 is front cross sectional view of the applicator device taken along the line N-N of FIG. 3;

FIG. 5 is front view of the gripping portion of FIG. 1;

FIG. 6 is front cross sectional view of the gripping portion taken along the line N-N of FIG. 5.

FIG. 7 is an isometric view of a kit in open position containing the applicator device according to an embodiment of the present invention.

FIG. 8 is an isometric view of cosmetic kit containing the applicator device according to an embodiment of the present invention.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

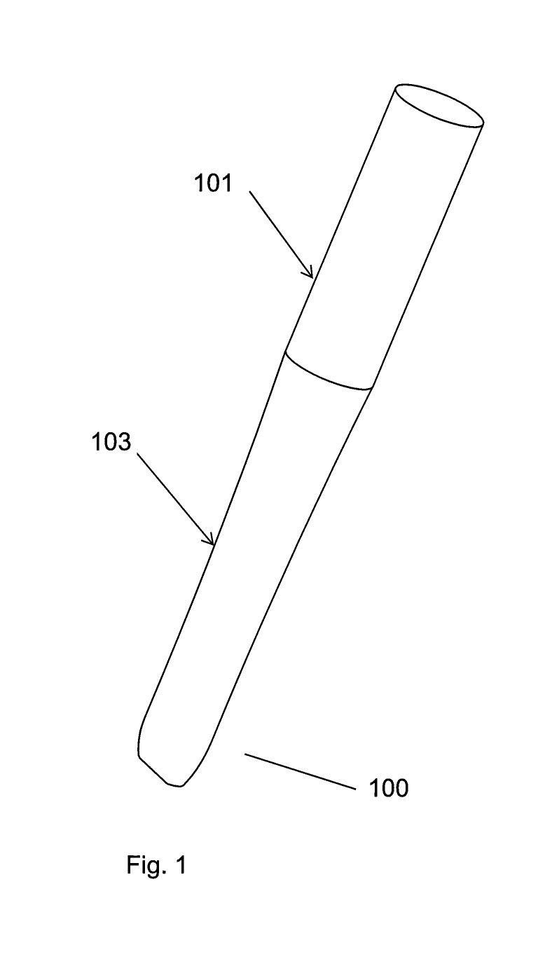

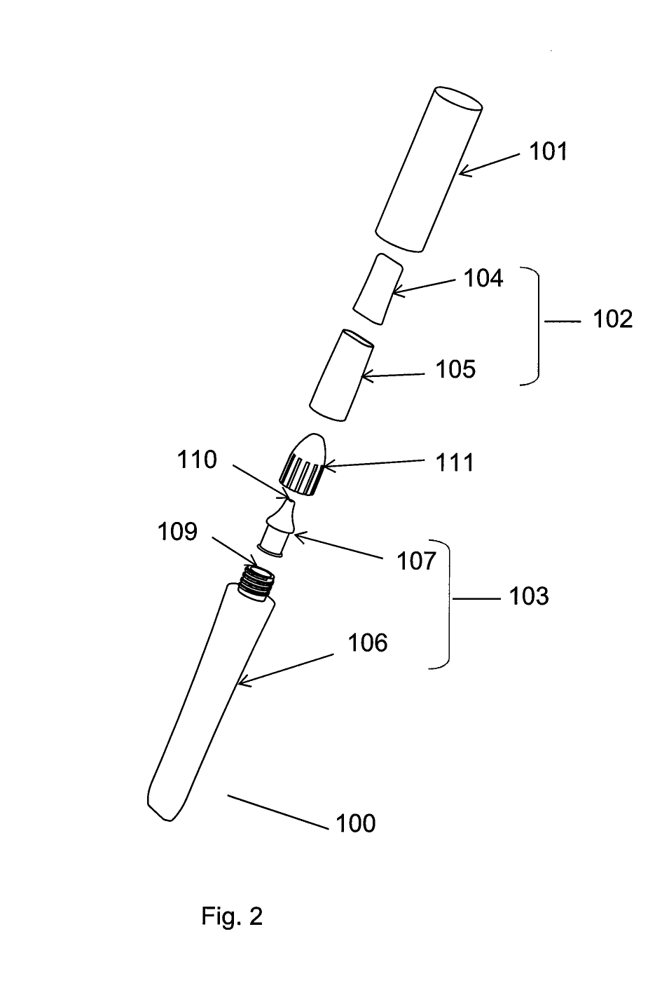

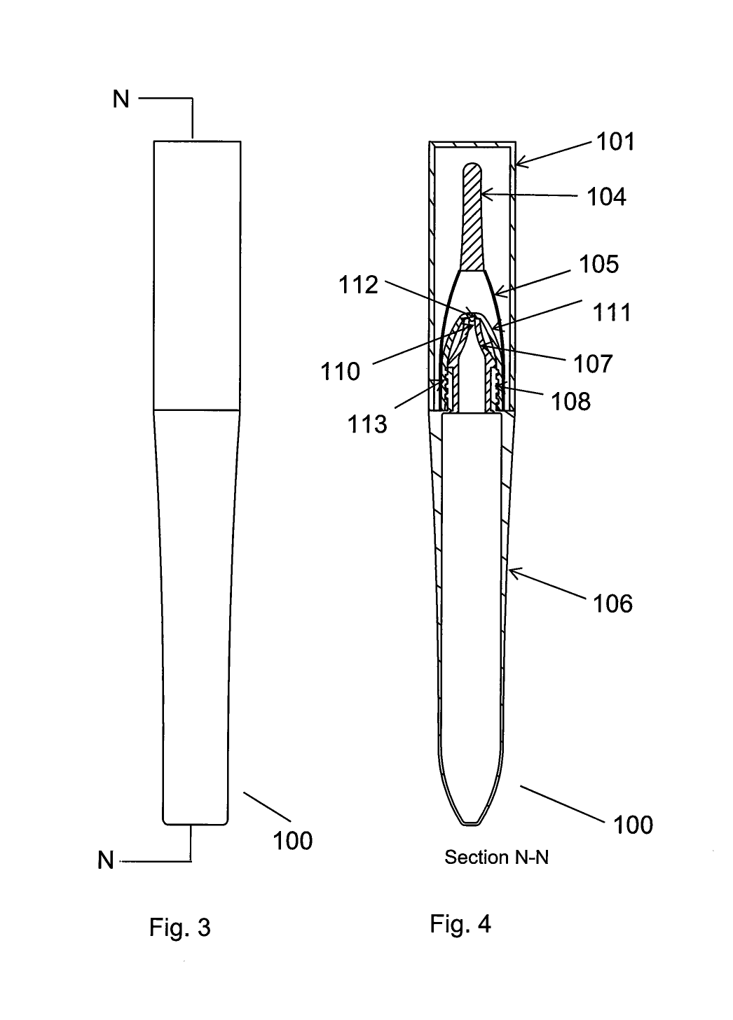

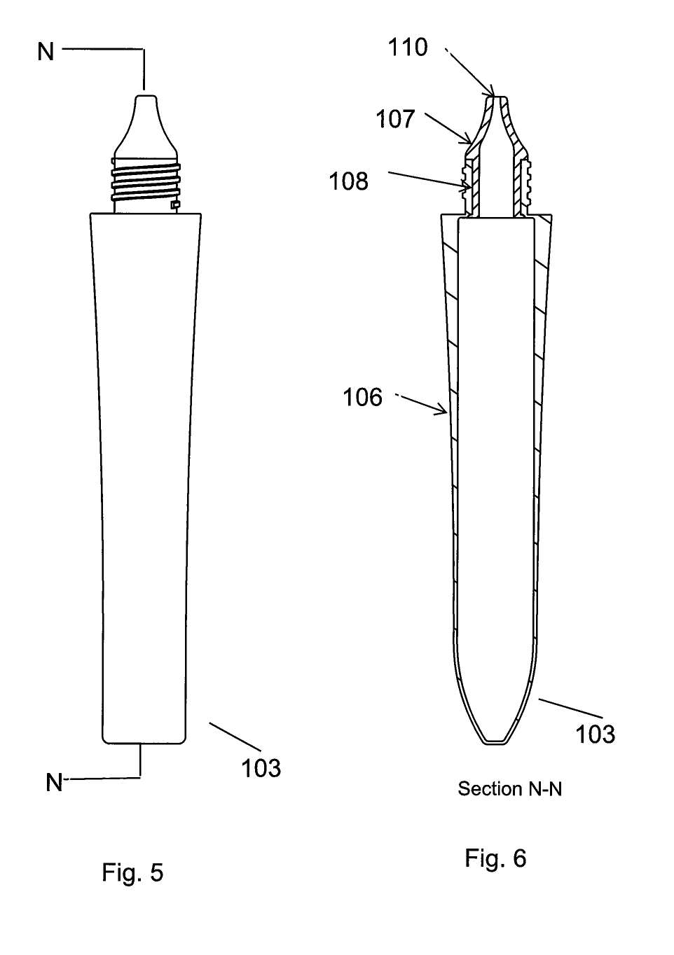

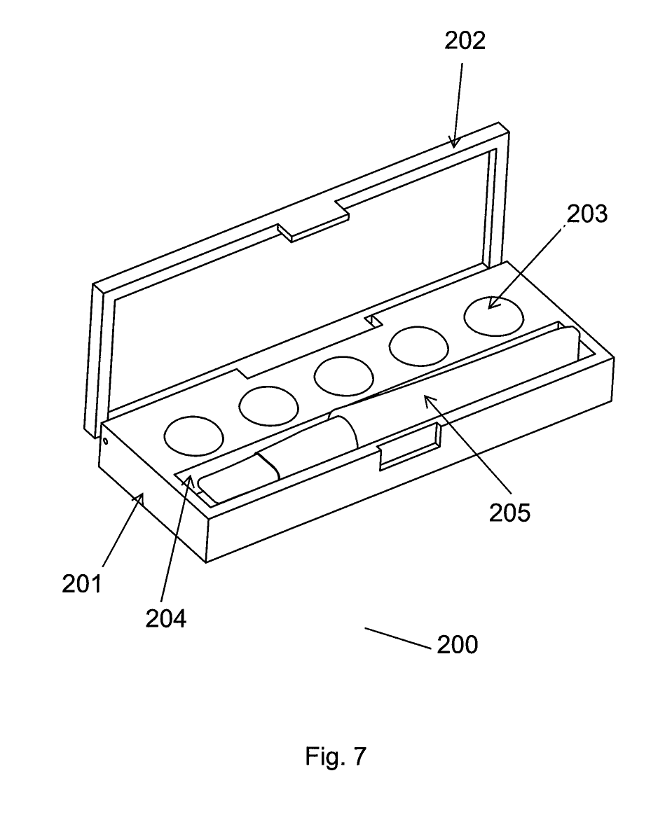

The applicator device according to one embodiment of the present invention is shown in FIGS. 1 to 6. FIG. 1 is one embodiment of the present invention showing the applicator device 100. The applicator device 100 comprises a cap 101, a head portion 102 and a gripping portion 103. The cap 101 may be formed from any suitable material or a polymeric material such as polypropylene, acrylonitrile butadiene styrene or styrene acrylonitrile or any other suitable material. As shown in FIGS. 2 to 6, the head portion further comprises of an applicator element 104 and an applicator element holder 105. The gripping portion 103 comprises of an elongated housing 106 to which is attached a spout 107. The housing 106 terminates into a neck 108 which defines an opening 109. The housing 106 acts as a receptacle for containing the product. The spout 107 terminates into an opening 110 and the spout 107 could be shaped according to the composition of the product stored in the housing 106. As shown in FIGS. 2 to 6, the outer circumference of the neck 108 of the housing 106 has a threaded portion to enable screwing of the head part 102 thereby sealing the spout opening 110. The housing 106 may be formed of a suitable polymeric material such as polypropylene or surlyn while the spout 107 could be made from a suitable polymeric material such as polypropylene. The distal portion of the spout 107 locks the opening of the housing 106.

As represented by FIGS. 2 to 6, the applicator element holder 105 is further provided with an inner cap 111 that is inserted into the applicator element holder 105 to partition the applicator element holder 105 into two parts wherein the inner cap 111 has a protrusion 112 projecting towards its distal end so as to close the opening 110 of the spout 107. Further, the inner cap 111 on its outer circumference has provision to be one-time fitted into the applicator element holder 105 while the inner circumference of the inner cap 111 has complimentary threads 113 to enable mounting of the head portion 102 onto the housing 106. The applicator element holder 105 could be formed of a suitable metal or a suitable polymeric material such as polypropylene. The applicator element 104 may be constructed of a porous or non-porous rubber, fabric mesh, felt material, foamed polymers, sponge material or any other suitable material. Also, the applicator element 104 could have any suitable shape depending on the kind of application required. It could also have a shape other than round such as flattened brushes. The inner cap 111 may be formed from any suitable material or a polymeric material such as polypropylene or any other suitable material.

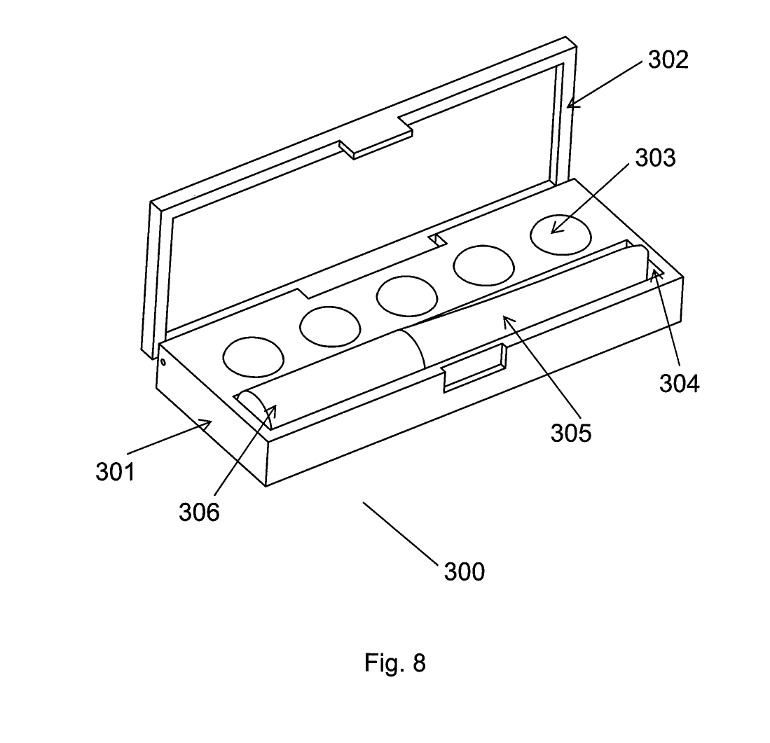

As shown in FIG. 7, the cosmetic kit 200 comprises of a base 201 and a cover 202. The cover 202 is hingedly connected to the base 201. In the base 201 are placed pans for receiving the cosmetic products wherein either one of them is a mixing well 203. In the base is also provided a recess 204 to accommodate the applicator device 205 of the present invention.

As shown in FIG. 8, the cosmetic kit 300 comprises of a base 301 and a cover 302. The cover 302 is hingedly connected to the base 301. In the base 301 are placed pans for receiving the cosmetic products wherein either one of them is a mixing well 303. In the base is also provided a recess 304 to accommodate the applicator device 305 having a cap 306.

Although the above description and drawings show the applicator device 100, and in particular the housing 106 thereof, being cylindrical, the shapes and profile cross section thereof are not limited to the same.

Various examples of the products which the kit 200 or 300 may contain are at least one of a cosmetic, a hair care product, a skin care product or a paint product whereas the applicator holder 205 and 305 may contain an additional consumer product that has a complimentary composition to the products of the kit. Various examples of cosmetic products include that the kit may contain include but are not limited to pressed powder, baked powder, loose powder, hot pour cosmetics or cremes whereas the applicator holder 205 and 305 may contain an additional cosmetic product such as a shimmer, converter, primer or gel.

These and further aspects which will be apparent to the expert of the art are attained by an applicator device in accordance with the main claim.

While the foregoing is directed to embodiments of the present invention, other and further embodiments of the invention may be devised without departing from the basic scope thereof, and the scope thereof is determined by the claims that follow.

What is claimed is:

1. An applicator device comprising:
a head portion, said head portion comprising an applicator element and an applicator element holder; and
a gripping portion, said gripping portion comprising an elongated housing wherein said housing has a neck that defines an opening
said applicator device characterized in that said elongated housing acts as a receptacle for containing a product and the head portion and gripping portion are arranged to be mounted onto each other such that the opening in the housing of the gripping portion gets sealed.

2. The applicator device according to claim 1 wherein the applicator element holder has a partitioning wall that separates the opening of the elongated housing from antecedant distal ends of the applicator element.

3. The applicator device according to claim 2 wherein the partitioning wall in the applicator element holder has a means to shut the opening of the elongated housing when the head portion is mounted on to the gripping portion.

4. The applicator device according to claim 3 wherein the means to shut the opening of the elongated housing is a protrusion projecting towards the distal end of the applicator element holder.

5. The applicator device according to claim 4 wherein the head portion has a plurality of applicator elements such that said head portion is used interchangeably on the gripping portion.

6. The applicator device according to claim 5 wherein a spout is optionally attached to the opening of the elongated housing.

7. The applicator device according to claim 6 wherein said applicator device optionally comprises an inner cap that is inserted into the applicator element holder to form the partitioning wall.

8. The applicator device according to claim 7 wherein said applicator device optionally comprises a cap to cover the applicator element.

9. The applicator device according to claim 8 wherein the cap is provided with a mixing well on its proximal end to enable a user to dispense the product into the well for usage with the applicator.

10. A kit comprising a base and a cover wherein said cover is hingedly connected to the base, and said base has at least one pan for receiving the cosmetic products wherein one of the at least one pan is a mixing well, wherein in the said base is provided a recess wherein said recess accommodates the applicator device as claimed in claim 8.

11. The kit according to claim 10 wherein the housing of said applicator device contains an additional product having an complimentary composition to the products of the kit.

12. The kit according to claim 11 wherein said kit contains at least one of a cosmetic, a hair care product, a skin care product or a paint product.

13. The applicator device according to claim 1 wherein said applicator device is compact and portable.

14. The applicator device according to claim 1 wherein the product stored in the receptacle of the housing comprise at least one of consumer product such as a cosmetic, a hair care product, a skin care product or a paint product.

15. The applicator device according to claim 1 wherein the applicator provides for a multiple usage with a single head component applicator element.

16. An applicator device comprising a head portion and a gripping portion wherein
said head portion comprises an applicator element and an applicator element holder; and
said gripping portion comprises an elongated housing wherein the elongated housing is having a neck that defines an opening wherein
the applicator element holder has a partitioning wall that separates the opening of the elongated housing from the distal ends of the applicator element wherein
the partitioning wall in the applicator element holder has a means in the form of a protrusion projecting towards the distal end of the applicator element holder to shut the opening of the elongated housing when the head portion is mounted on to the gripping portion
said applicator device additionally comprises
a spout attached to the opening of the elongated housing;
an inner cap that is inserted into the applicator element holder to form the partitioning wall; and
a cap to cover the applicator element wherein the cap is provided with a mixing well on its proximal end to enable a user to dispense a product stored in the elongated housing into the well for usage with the applicator element,
said applicator device characterized in that said elongated housing acts as a receptacle for containing the product and the head portion and gripping portion are arranged to be mounted onto each other such that the opening in the housing of the gripping portion gets sealed.
